(19) United States
(12) Patent Application Publication
(10) Pub. No.: US 2015/0224665 A1
(43) Pub. Date: Aug. 13, 2015

(54) PLASTIC FOAM BOARD AND METHOD FOR THE PRODUCTION THEREOF

(71) Applicant: Kamal MOSTAFA, (US)

(72) Inventor: Kamal Mostafa, Gizeh (EG)

(21) Appl. No.: 14/383,953

(22) PCT Filed: Oct. 25, 2012
(86) PCT No.: PCT/IB2012/055873

§ 371 Date: Sep. 9, 2014

(51) Int. Cl. B26D 7/00; E04B 1/80

(52) U.S. Cl. CPC B26D 7/00; E04B 1/803

(57) ABSTRACT

A method for improving the thermal insulating properties of closed-cell plastic foam boards (10) that have a front surface (11), a rear surface (12) opposite the front surface (11), and a first thickness (D₁) which is delimited by the front and rear surfaces (11, 12), characterised by the steps: heating the board (10) to a temperature of 30° C. to 95° C.; pressing the board (10) after or during heating by conveyance through a press roller train (13), a press gap (D₃) formed in the press roller train being ½ to 1/20 of the first thickness (D₁); and air-diffusion-tight coating of the board (10) immediately after the pressing step. The invention further relates to a plastic foam board (10′) produced by the method.

The invention relates to a method for improving the thermal insulation properties of closed-cell plastic foam boards, having a front surface and a rear surface opposite the front surface and a first thickness which is delimited by the front and rear surfaces. The invention further relates to a plastic foam board of a closed cell plastic foam, having a front surface and a rear surface opposite the front surface and a first thickness delimited by the front and back surface.

Closed cell plastic foam is composed of hollow cells separated by a continuous thin plastic membrane. It is normally referred to as closed-cell foam if the ratio between the number of the closed cells in the foam as compared to the total cell number is preferably 95% or more. Such foamed plastic boards are commercially available as, for example, extruded polystyrene foam boards (XPS). The construction polystyrene foam boards known in this form generally have good thermal insulation properties and low thermal conductivities X of about 0.03 to 0.04 W/mK.

To meet the increasing demands of energy saving, the insulation materials selected for structural engineering reasons are getting thicker, whereby valuable internal space is lost. For this and other reasons, reductions in the thermal conductivity of insulating materials are always sought after. It is against this background that there is a need for improved thermal insulation materials for the construction industry and/or methods to improve known heat insulation materials with respect to their thermal insulation behavior. At the same time there is a fundamental interest to optimize other properties of the known plastic foam boards, such as their water absorption, sound insulation and mechanical properties, wherein these aspects are less in the foreground of the present invention.

Some earlier developments in this direction are known, for example from the teachings of U.S. 2011-0064938 A1, EP 0863175 A2, EP 0372343 B1 and EP 1486530 A1, within which, for example, carbon black or graphite are proposed as additives for plastic foam boards, whereby a reduction in the thermal conductivity of polystyrene foam boards could be achieved. A disadvantage noted at the same time is, however, that these products have a very dark color, which always leads to their warping or deformation at construction sites to due to their excessive heating. Another disadvantage of plastic foam boards with carbon black or graphite components is their relatively higher price.

Also known are the so-called vacuum insulation panels (VIP), which consist of a high-vacuum core and a gas-impermeable film coating. The core is usually made of a porous material or of open-cell plastic foams. Although these panels have a very low λ value of about 0.006 to 0.0012 W/mK, they are however very production-intensive and therefore more expensive. Another disadvantage is the rapid loss of their excellent thermal insulation properties in the case of mechanical damage of the panel film coating which is uncorrectable.

Another solution is offered by JP 2002-14497A, in which a foam board is coated as soon as possible after the production with a gas-impermeable material, so that the exchange between the production gasses (which have a lower λ-value as the air) contained in the foam and the ambient air is hindered. However, this method has the disadvantage that most of the production gases and the usually simultaneously applied flame retardant components remain in the foam. Also for the purpose of extending the aging time U.S. 2010-0304075A1 suggests the coating of freshly produced polystyrene foam (EPS) with a gas-impermeable coating.

U.S. Pat. No. 4,299,883 A proposes to improve the sound absorption of polycarbodiimide foams by pressing and crushing of foam cell walls. No improvement in heat insulation is achieved by this method.

EP 0 792 732 A1 proposes the flexibilization of open-cell polyurethane foam panels by pressing and fracturing their open cell walls. Although this method simplifies the installation, it does not improve the thermal insulation.

U.S. Pat. No. 5,520,873 describes a compression method for improving of the dynamic rigidity of foam boards by pressing and releasing the foam board 5 to 10 times. The effect of this method is demonstrated only for polystyrene foam (EPS).

EP 0056121 B1 proposes the compression of foam board made of polystyrene particle foam in such a manner that cells exhibit a ratio of compression of long and short axis in a range between 1.3 and 1.6. From the disclosed embodiments it can be seen that for the achievement of the desired cell axis ratio a compression between two plane-parallel boards over a period of 30-90 seconds is required. As obvious drawbacks of such a method, the resulting higher density and the greater cost can be mentioned. At the same time there is a risk of breakage of the cellular structure.

As another method for increasing the flexibility of the cross-linked closed-cell polyolefin foam boards, U.S. 2008-003421 A1 proposes pressing the boards between one or two sets of rollers, wherein the speeds of the opposing rollers is different. This results in additional shear stresses, with the stated aim to break or open higher proportions of closed cells. An improvement of the thermal insulation is not mentioned and probably not expected.

U.S. 2011-0229693 A1 describes a method for producing foam boards with structured surfaces, wherein the foam boards are pressed by a roller system having appropriately structured roller surfaces. An improvement of the thermal properties is not intended in that method.

U.S. Pat. No. 3,443,007 A describes a method for sealing the polyurethane foam surfaces, wherein the surface is pressed under high temperature. This melts the surface and forms a dense polyurethane skin. In this method, for example, heated rollers are applied. The objective of this method is not to improve the heat-insulating, but only some of the mechanical properties, of the polyurethane foam elements.

A process of molding or pressing plastic foam boards at a temperature between 50° C. and 95° C. has already been described by the inventor in an earlier German patent application Serial No. 10 2011 119 607.6. However, it achieves an improvement of the thermal insulation of the board only by the modification of cell morphology.

The object of the invention is therefore to find a simple and economic solution to reduce the thermal conductivity of traditional closed foamed plastic boards and therefore to achieve higher energy savings at a lower thickness.

The inventive method provides a roller pressing-out in its thickness direction of a closed cell plastic foam board in tempered condition, which is then coated immediately with an air-impermeable material. The board has a temperature of between 30° C. and 95° C. prior to rolling and/or during the roller pressing-out process. These elevated temperatures during the roller press-out process speed up the gas diffusion through the cell walls, whereby a rupturing of the closed cells is prevented. Investigations in accordance with ASTM D 6226-10 have proved that the proportion of open cells hardly increased by the pressing of an extruded polystyrene foam board in the inventive tempered condition.

The gap between the rollers in the pressing direction is ½ to 1/20 of the first thickness of the previously conventionally produced foamed plastic boards so that the production gases trapped in the cell are effectively pressed out and, if possible, no closed cells are disrupted into open cells.

In view of this goal, the number of press roller pairs is determined. Their number depends mainly on the board thickness at the beginning of the pressing process, the temperatures of the board during the pressing and the blowing agents used. The number of the pressing roller pairs can be between one pair and ten pairs or more.

At the end of the roller press-out process the board thickness again increased to a second thickness (reversible compression), which is reduced compared to the first thickness, wherein a partial vacuum is created in the closed cells of which the production gases were forced out. The boards are assembled as quickly as possible to the desired size and coated with a suitable air-impermeable material so that the pressure in the cells remains low.

To prevent the increase in the density of the board by the pressing, the rotating speeds of the roller pairs along the press roller train are step-wise increased, causing a gradual stretching of the board in the longitudinal direction (along the compression train).

According to the findings of the inventor, most of the trapped gas in the cells, preferably virtually all of the gas, is forced out of the board during the pressing process. Only in the process of re-expansion of the panel, starting from the thickness at the end of the compression train (roller gap) up to the second thickness after the end of the reversible compression, will a vacuum first be formed in the closed cells. The board is coated immediately after the roll-out process with a suitable air-impermeable material, which protects the vacuum in the closed cells, causing a significant long-term improvement of thermal insulation of the board to be achieved.

According to the invention the value of vacuum in the closed cells of the board is preferably less than 500 millibars, and more preferably less than 100 millibars. It is also worth mentioning, and probably already known, that the smaller cell size in the direction of board thickness resulting from pressing results in an additional reduction of the thermal conductivity and thus improves the thermal insulation in the board thickness direction.

Thanks to the cells of the board, which remain closed even after the pressing, the surrounding air may slowly penetrate into the board, so the low pressure in the closed cells is not directly affected. Therefore, sufficient time remains for the application of the air-impermeable coating material.

Another advantage of the closed cells is that mechanical damage, such as drilling, cutting, nailing, screwing or impacting, does not result in a rapid loss of vacuum in the cells (as in the case of the known VIP panels). The effect is localized and affects the thermal insulation of the inventive board only after a long time, so that enough time is left to correct such damage with a suitable repair material can.

So that the primary, propellant gas charge contained in the cells of the foam can diffuse out faster during pressing, it is advantageous and is a preferred embodiment, when the method proposed here, prior to pressing, includes a surface treatment of the supplied plastic foam boards. The surface treatment can be
a milling of the top outer face on the side of the front surface and/or the rear surface,
a grinding off of the top outer face on the side of the front surface and/or the rear surface,
a cutting or sawing off of the top outer face on the side of the front surface and/or the rear surface and/or
a perforating with a needle roller on the side of the front surface and/or the back surface.

Determining the initial thickness (the first thickness) of the plastic foam board is then carried out after this surface treatment.

According to the invention, during the pressing the boards are at a temperature in a range of between 30° C. and 95° C., preferably between 50° C. and 75° C. and particularly preferably between 65° C. and 75° C. These temperature ranges are based on the surface temperature and the temperature inside of the flat foamed plastic boards. As an option, it is preferred when the method comprises a heating of the boards before pressing as well as during pressing, such as by heated pressing rollers.

In order to achieve a substantial optimization in the production of the board, it is conceivable and regarded as preferred, to integrate the machine for the continuous production of extruded foamed plastic boards in the inventive production line for a method for producing the boards. Thereby one uses the energy of the warmth present immediately after production of the original board to greater efficiency, mainly because the temperature of the board is still high not only outside, but also in its interior.

Particularly in view of environmental aspects and/or economic reasons, the process step of pressing is carried out within a housing or an enclosure for the collection, controlled transfer and, where appropriate, in the preferred embodiment also for re-utilization of blowing agent pressed out of the boards. This can also make it possible to use certain blowing agents, which exhibit excellent foaming properties, but of which the use has been prohibited in recent years for environmental reasons, such as CFC (chlorofluorocarbon) and HCFC-(hydrogenated chlorofluorocarbon).

In reflecting on the previous paragraph, with regard to the method proposed here all known blowing agents for plastic foam manufacture are suitable, in particular inorganic blowing agents, such as: carbon dioxide, nitrogen, air, argon, helium, water; organic blowing agents such as methane, ethanol, propane, n-butane, isobutane, n-pentane, neopentane, cyclobutane, cyclopentane, difluoroethane (HFC-152a), tetrafluoroethane (HFC-134), difluoroethane (HCFC 142 b), chlorodifluoromethane (HCFC 22); and/or chemical blowing agents such as azodicarbonamide, p-toluene.

A particularly preferred plastic for forming the plastic foam board is polystyrene plastic. In a preferred embodiment the polystyrene resin is combined with other synthetic materials, selected from the list comprising acrylonitrile, polymethacrylates, rubber, polyethylene, and/or additives, individually or in combination, selected from the group comprising: carbon black, graphite, titanium dioxide, hexabromocyclododecane, triphenyl phosphate, talc, calcium carbonate, kaolin, calcium stearate, magnesium oxide, which may also be in micro- or nano-form. With these or other plastic materials and/or additives in combination with the proposed molding method, physical and/or mechanical properties of the board can be improved, including, inter alia, the properties of thermal insulation, water absorption, fire resistance, dimensional stability, compressive strength, flexural strength, tensile strength.

As preferred gas diffusion-tight coating materials there may be e.g. epoxies, polyurethanes, polyvinyl alcohol, polyester, latex, metallized coatings, aluminum foil and thicker polstyrol skins, e.g. by board surface melting or ironing on. In the selection of suitable coating should take into account the recycling aspects. These or other coatings will protect the resulting vacuum in the cells from pressure rise in the proposed method. At the same time, other physical properties of the board, such as water absorption and sound insulation as well as mechanical properties of the board, such as bending and tensile strength, abrasion resistance and scratch resistance can be improved.

In order to produce a board of a certain thickness according to this invention, one can press a single thicker plastic foam board to the desired thickness. It is also possible to produce thinner plastic foam panels and to obtain the desired board thickness by doubling, or generally by means of multiple stacking; thus it is a preferred embodiment of the proposed board, to permanently connect this board with a second identically constructed board, for example, by bonding. It is possible to achieve through this multiple stacking an even significantly lower thermal conductivity of the composite stack than is possible with an equally thick, but unstacked, plastic foam board.

It is considered a further preferred embodiment of the proposed plastic foam board when a surface of this board is indissolubly connected with another board of at least one other material.

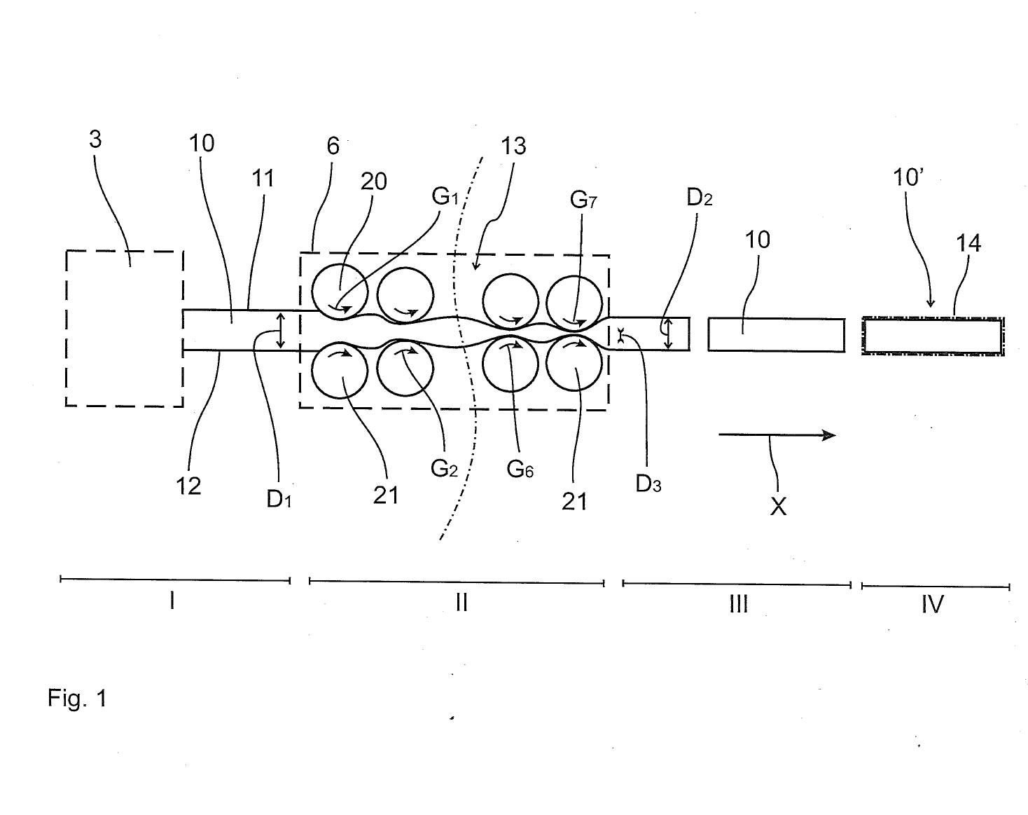

In the following the invention is described in detail with reference to the drawing. Therein FIG. 1 shows an exemplary integrated production line for the continuous production of pressed and drawn extruded plastic foam panels 10′, starting with the production line 3 in section I for such plastic foam board 10, of which the first thickness (manufacturing thickness) D₁ in the illustrated case is about 60 mm.

Section II demonstrates the use of a press roller train 13. The press roller train 13 has a plurality of pairs of rollers 21, 22 arranged one after the other in the machine direction, which have a gap D₃ which decreases in the transport direction from press roller pair to press roller pair 20, 21, wherein the press gap D₃ at the end of the press roller train 13 is only 5 to 8 mm. In the illustrated embodiment in FIG. 1, seven pairs of rollers 20, 21 are provided, of which respectively only the first and the last two are shown. In the transport direction of the plastic foam boards 10, the rotational speed increases progressively from G1 to G7, as indicated with the movement arrows G1 to G7 in FIG. 1.

The pressing rollers 20, 21 have, in this example, an outside diameter of 250 mm and are not heated in the case shown, which is however generally preferred. The mean temperature of the board 10 immediately before the pressing is about 75° C. and at the end of the pressing is about 60° C. The entire region in which the supplied plastic foam board 10 is pressed by the pressing rollers 20, 21 is enclosed by means of a housing 6 for the collection, transfer and controlled re-use of blowing agent (from the board 10). At the end of Section II, a re-expansion of the plastic foam board 10 takes place, starting from the thickness corresponding to the gap D₃, immediately at the end of the press roller train 13, to a thickness D₂ (second thickness) of about 55 mm in accordance with reversible compression.

In section III, the assembly of the boards 10 to the desired size is carried out, and finally, in section IV, the air diffusion-tight coating 14 is applied on all sides, to protect the negative pressure in the closed cells from loss. As air diffusion-proof material, solvent-free epoxy resin is used in this illustration. Ultimately there is a complete encased plastic foam board 10′, which has a much better λ-value than the untreated board 10.

The present invention will be further illustrated by the following examples, wherein the manufacturing of the herein disclosed foamed plastic boards is performed on a machine, as shown schematically in FIG. 1.

### EXAMPLE 1

An XPS foam plastic board 10 with an initial thickness (the first thickness D₁) of 60 mm and a density of 32.0 kg/m³, which has been prepared with the blowing agent HFC-152 a, in temperature state of about 75° C. to 60° C., is extruded and drawn and decreased to a final thickness (second thickness D₂) of approximately 55 mm and a density of about 31.5 kg/m³. The resulting board 10 is coated after the assembly with a solvent-free epoxy resin of about 100 microns. Table 1 includes the results thereof.

TABLE 1

| | Original XPS board (10) | | Inventive XPS board (10′) | |
|---|---|---|---|---|
| Thickness | about 60 mm | | ca. 55 mm | |
| Thickness | 32.0 | kg/m³ | 31.5 | kg/m³ |
| closed cells | about 97% | | about 97% | |
| λ −10° C. | 0.0282 | W/mK | 0.0186 | W/mK |
| after 1 day | | | | |
| λ −10° C. | 0.0315 | W/mK | 0.0186 | W/mK |
| after 180 day | | | | |

### EXAMPLE 2

A synthetic foam board 10, having an initial thickness (the first thickness D₁) of 53.0 mm and a density of 35.5 kg/m³, which was prepared with a blowing agent mixture CO2/DME, in a temperature state of about 75° C. decreasing to 65° C., is extruded and drawn to a final thickness (second thickness D₂) of about 50 mm and a density of 34 kg/m³. Table 2 shows the therefrom resulting data:

TABLE 2

| | |
|---|---|
| Original XPS board 10 | Inventive XPS board 10′ |

| | | | |
|---|---|---|---|
| Thickness | 53.00 | mm | ca. 50 mm |

| | | |
|---|---|---|
| Density | about 35.5 kg/m³ | about 34.0 kg/m³ |
| closed cells | about 95% | about 95% |

| | | | |
|---|---|---|---|
| 10° C. λ | 0.0318 | W/mK | 0.0204 W/mK |
| after 1 day | | | |
| 10° C. λ | 0.0372 | W/mK | 0.0204 W/mK |
| after 90 days | | | |

The Examples demonstrate that the present invention provides a simple and economical method to significantly reduce the heat conductivity of traditional foamed plastic boards and consequently to achieve improved energy savings with reduced board thickness. Furthermore, it is assumed that the thermal conductivity of the plastic foam board 10′ produced in accordance with the present invention is significantly lower than that of the above-mentioned examples, when the cell morphology of the original board 10 is more appropriate, which is enabled, for example, by the application of preferred blowing agents.

### LIST OF REFERENCE NUMERALS

3 plastic foam board production line
6 housing, housing
10 plastic foam board
10′ plastic foam board, and pulled gepressr
11 front surface
12 rear surface
13 press roller train
14 coating of air diffusion-proof material
20 roller
21 roller
D₁ first thickness, production thickness
D₂ second thickness, final thickness
D₃ press gap
G1-G7 rotation speed
X direction of transport

1. A method for improving the thermal insulation properties of a closed-cell plastic foam board (10), which has a front surface (11) and a rear surface (12) opposite the front surface (11) and a first thickness (D₁) delimited by the front and rear surfaces (11, 12), the method comprising the steps of
a) heating the board (10) to a temperature of 30° C. to 95° C.,
b) pressing the board (10) after and/or while heating by passage through a conveying press roller train (13), wherein a roller press gap (D₃) in the press roller train is ½ to 1/20 of the first thickness (D₁), and
c) sealing the board (10) immediately after the pressing process with an air diffusion-proof material.

2. The method of claim 1, wherein the press roller train (13) has at least two pairs of rollers, wherein the transport velocities (Gₙ) of the roller pairs (20, 21) gradually increase along the press roller train (13) in the transport direction (X) of the board (10).

3. The method according to claim 1, wherein before the pressing there occurs:
a) milling of the outermost surface on the side of the front surface (11) and/or the rear surface (12);
b) abrading of the outermost surface on the side of the front surface (11) and/or the rear surface (12);
c) a cutting or sawing off of the outermost surface on the side of the front surface (11) and/or the rear surface (12); and/or
d) a perforation with the needle rollers of the front surface (11) and/or the rear surface (12).

4. The method according to claim 1, wherein supplied boards (10) are heated to 65° C. to 75° C. before pressing and/or during pressing.

5. The method according to claim 1, wherein blowing agent pressed out from the boards (10) during the pressing is captured and re-used.

6. The method according to claim 1, wherein the method for improving thermal insulation properties is performed immediately after a production line (3) for manufacturing of plastic foam board (10) as a continuous production line for the manufacture of the board (10′).

7. A plastic foam board (10′), produced from a of closed-cell plastic foam board with a front surface (11) and a rear surface (12) opposite the front surface (11) and a first thickness (D₁) delimited by the front and the rear surfaces (11, 12), wherein the plastic foam board, following manufacture, is pressed with the board at a temperature of 30° C. to 95° C. through roller press gap (D₃) ½ to 1/20 of the first thickness (D₁) and drawn, and at least the front and the back surfaces (11, 12) exhibit a coating made of air diffusion-proof material (14).

8. The plastic foam board (10′) according to claim 7, wherein the plastic for forming the plastic foam board (10) is polystyrene plastic, optionally combined with one or more other synthetic materials selected from the group consisting of acrylonitrile, polymethacrylates, rubber, polyethylene, and/or additives, selected from the group consisting of carbon black, graphite, titanium dioxide, hexabromocyclododecane, triphenyl phosphate, talc, calcium carbonate, kaolin, calcium stearate, magnesium oxide, optionally in micro- or nano-form.

9. The plastic foam board (10′) according to claim 7, wherein the air diffusion-proof material (14) is selected from the group consisting of epoxides, epoxy resins, polyurethanes, polyvinyl alcohol, polyester, latex, metallized coatings, aluminum foil, thicker polystyrol skin.

10. The plastic foam board (10′) according to claim 7, wherein a blowing agent for the production of the foam board (10) is selected from the group consisting of inorganic blowing agent and organic blowing agents.

11. A plastic foam board (10′) according to claim 7, wherein the pressure in the cells is less than or equal to 500 millibars.

12. A plastic foam board (10′) according to claim 7, wherein the board (10′) is insolubly connected with a further board (10′).

13. A plastic foam board (10′) according to claim 12, wherein the further board (10′) is made of a same material as the first board (10′).

14. The plastic foam board (10′) according to claim 10, wherein the inorganic blowing agent is selected from the group consisting of carbon dioxide and nitrogen.

15. The plastic foam board (10′) according to claim 10, wherein the organic blowing agent is selected from the group consisting of n-butane, isobutane, difluoroethane, and p-toluene sulfonyl semicarbazide.
